(19) United States
(12) Patent Application Publication
(10) Pub. No.: US 2026/0021999 A1
(43) Pub. Date: Jan. 22, 2026

(54) CLAMP FOR HANDLING RACKS OF ELECTRONIC EQUIPMENT

(71) Applicant: Hyster-Yale Materials Handling, Inc., Fairview, OR (US)

(72) Inventors: Pietro Foroni, Casalpusterlengo (IT); Fabio Radaelli, Milano (IT); Davide Veneziani, Piacenza (IT); Riccardo Zignani, Casalpusterlengo (IT)

(73) Assignee: Hyster-Yale Materials Handling, Inc., Fairview, OR (US)

(21) Appl. No.: 19/273,227

(22) Filed: Jul. 18, 2025

Related U.S. Application Data
(60) Provisional application No. 63/672,992, filed on Jul. 18, 2024.

(51) Int. Cl. B66F 9/18; B66F 9/20

(52) U.S. Cl. CPC B66F 9/183; B66F 9/20

(57) ABSTRACT

A clamp is configured to be connected to a materials-handling vehicle and to lift and carry a rack housing electronic equipment. The clamp comprises a frame connected to a vertically moveable mast of the materials-handling vehicle and a pair of opposing arms connected to the frame. Each arm is horizontally moveable relative to the frame such that the arms can move inward toward each other and outward away from each other. Each arm comprises a lifting pad on or near a bottom of the arm and configured to fit underneath the rack on a side of the rack; an inward-facing surface configured to snugly contact a side of the rack when the arms are in a closed position; and, optionally, a load stop, along an edge of the arm distal from the frame, configured to inhibit tipping of the rack away from the frame.

### RELATED APPLICATIONS

This application claims priority to U.S. provisional patent application No. 63/672,992, entitled “CLAMP FOR SERVER HANDLING,” filed Jul. 18, 2024. The entire disclosure of the foregoing priority application is incorporated by reference herein.

### TECHNICAL FIELD

This disclosure relates generally to materials-handling equipment. This disclosure relates more specifically to equipment for moving racks of electronics gear, such as computer server racks, for example.

### BACKGROUND

With reference to FIG. 1, server racks 5 containing computer equipment 10 may need to be moved around a data center 15. For example, server racks 5 containing new computer equipment 10 may be delivered to the data center 15 and need to be moved into an operating place within the data center 15. Additionally, server racks 5 containing old computer equipment 10 may need to be moved from their operational location within the data center 15 to a loading dock, lorry, or other suitable area for transport to a facility where the computer equipment may be recycled or upgraded.

With further reference to FIG. 1, an existing technology for moving server racks 5 is described. Server racks 5 contain wheels that allow them to be manually pushed on the floor of a data center 15. When one or more server racks 5 need to be moved, the server racks 5 are manually pushed into position on a trolley 20 that contains a lifting mechanism operated by controls 25. Once a server rack 5 has been manually pushed into position on the trolley 20, the lifting mechanism is operated by controls 25 with the server rack 5 clear of the floor. A hitch 30 is used to connect the trolley 20 to a towing vehicle, such as an automated towing vehicle 35. The towing vehicle is used to move the trolley 20 bearing the server racks 5 within the data center 15 proximate to a desired location such as an equipment installed location for new computer equipment or a loading dock where old computer equipment is being replaced or recycled.

Once the server racks are proximate the desired location, the lifting mechanism is operated by controls 25 to lower the server rack wheels back onto the floor of the data center 15. The server racks 5 are then manually pushed clear of the trolley 20 and into a desired location.

### BRIEF DESCRIPTION OF THE DRAWINGS

FIG. 1 illustrates prior-art technology for moving a server rack using a trolley and a towing vehicle.

FIG. 2 is a side view of a first example clamp and first example vehicle for moving a server rack, according to one embodiment.

FIG. 3 is a side view of a first example clamp and second example vehicle for moving a server rack, according to another embodiment.

FIG. 4 is an isometric view of an example clamp and carriage for moving a server rack, according to one embodiment.

FIG. 5 is an isometric view of another example clamp and carriage for moving a server rack, according to another embodiment.

FIG. 6 is a side view of an example mast, carriage and clamp combination for moving a server rack, according to one embodiment.

FIG. 7 is a side view of another example mast, carriage and clamp combination for moving a server rack, according to another embodiment.

FIG. 8 is a top view of an example carriage for use with a clamp for moving a server rack, according to one embodiment.

FIGS. 9A and 9B are schematic top views of a vehicle and clamp combination approaching a server rack for pickup, showing an example of a server rack in an aligned position and a server rack in a mis-aligned position, according to one embodiment.

FIG. 10 is an isometric view of a first example clamp for moving a server rack, according to one embodiment.

FIG. 11 is an isometric view of a server rack on a pallet with computer equipment not illustrated for clarity.

FIG. 12 is a close-up side view of the server rack on the pallet of FIG. 11.

FIG. 13 is an isometric view of a vehicle bearing a first example clamp approaching a server rack for pickup in a first orientation, according to one embodiment.

FIG. 14 is an isometric view of a vehicle bearing a first example clamp engaging a server rack for pickup in a first orientation, according to one embodiment.

FIG. 15 is a bottom isometric view of a first example clamp engaging a server rack during pickup in a first orientation, according to one embodiment.

FIG. 16 is a front view of a first example clamp engaging a server rack in a first orientation, according to one embodiment.

FIG. 17 is a close-up detailed view of a contact pad and a lifting pad of the clamp engaging the server rack of FIG. 16.

FIG. 18 is an isometric view of a vehicle bearing a first example clamp moving a server rack in a first orientation, according to one embodiment.

FIG. 19 is a close-up front isometric view of a first example clamp holding a server rack in a first orientation, per FIG. 18.

FIG. 20 is an isometric view of a vehicle bearing a first example clamp dropping off a server rack in a first orientation, according to one embodiment.

FIG. 21 is an isometric view of a vehicle bearing a second example clamp approaching a server rack for pickup in a second orientation, according to one embodiment.

FIG. 22 is an isometric view of a second example clamp for moving a server rack, according to one embodiment.

FIG. 23 is a side view of a vehicle bearing a second example clamp engaging a server rack for pickup in a second orientation, according to one embodiment.

FIG. 24 is a close-up, side view of a portion of FIG. 23, showing a contact pad and a lifting pad of the clamp, according to one embodiment.

FIG. 25 is an isometric view of a vehicle with a second example clamp in a first step of engaging a server in a second orientation, according to one embodiment.

FIG. 26 is a bottom view of the second example clamp of FIG. 25.

FIG. 27 is an isometric view of a vehicle with a second example clamp in a second step of engaging a server in a second orientation, according to one embodiment.

FIG. 28 is a bottom view of the second example clamp of FIG. 27.

FIG. 29 is a close-up view of a portion of FIG. 28.

FIG. 30 is an isometric view of a vehicle with a second example clamp carrying a server in a second orientation, according to one embodiment.

FIG. 31 is a close-up view of a portion of FIG. 30.

FIG. 32 is an isometric view of a vehicle bearing a second example clamp dropping off a server rack in a second orientation, according to one embodiment.

FIG. 33 is a flowchart illustrating a sequence of operations using the clamps described herein to move a server rack, according to one embodiment.

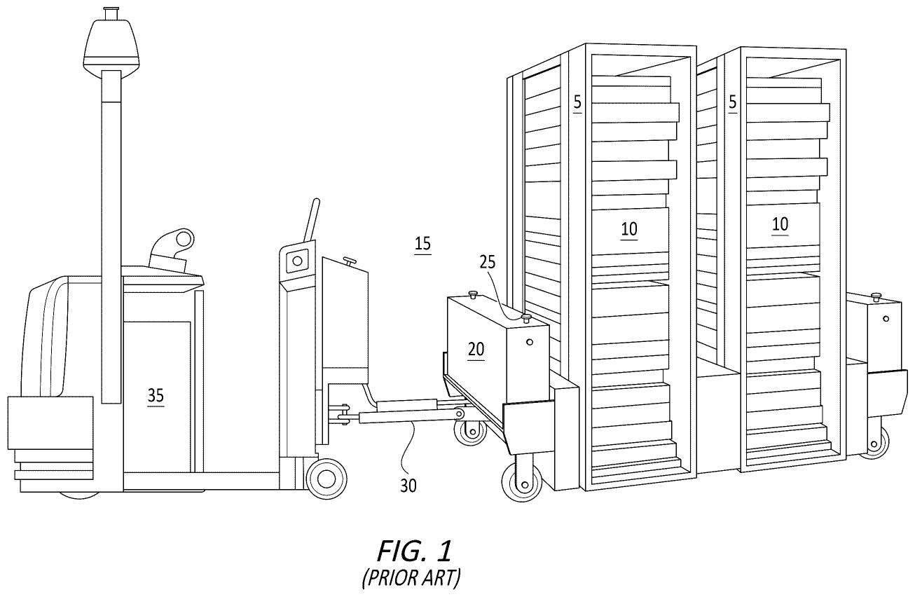

### DETAILED DESCRIPTION

### Preliminary Notes

Example embodiments are described below with reference to the accompanying drawings. Unless otherwise expressly stated, the sizes, positions, etc. of components, features, elements, etc., as well as any distances therebetween, are not necessarily to scale, and may be disproportionate and/or exaggerated for clarity.

The embodiments described herein are merely examples, set forth by way of illustration only and not limitation. Those skilled in the art will recognize in light of the teachings herein that there are alternatives, variations and equivalents to the example embodiments described herein and their component parts. For example, other embodiments are readily possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” “comprising,” “include,” “includes,” “including,” “has,” “have,” and “having,” when used in this document, are open-ended and specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another and not to imply any relative order, placement, or ranking. For example, one element could be termed a “first element” and similarly, another element could be termed a “second element,” or vice versa. The same is true of labels like (a), (b), (c) or (1), (2), (3), etc. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the drawings. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all functional or operative connections may be direct or indirect. Similarly, unless clearly indicated otherwise, all physical connections may be rigid or non-rigid, permanent or temporary, direct or indirect (e.g., via intermediary components).

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings. Additionally, the drawings may include non-essential elements that are included only for the sake of thoroughness. These non-essential elements may be removed entirely or left only in outline form if drawing changes are desired to create greater clarity.

Not every feature shown in every drawing is labeled with a reference number, even though the same feature may be labeled with a reference number on other drawings. Reference numbers have been omitted where it is believed they would unnecessarily clutter a drawing. However, all rights are reserved to add reference numbers to the drawings to clarify aspects of the embodiments. Moreover, some views omit some features shown in other views. Finally, the drawings sometimes illustrate variations from one drawing to another, even where those drawings are intended to depict the same embodiment.

### OVERVIEW OF EMBODIMENTS

According to one embodiment, a clamp is configured to be connected to a materials-handling vehicle and configured to lift and carry in a data center a rack housing electronic equipment. The clamp comprises a frame connected to a vertically moveable mast of the materials-handling vehicle and a pair of opposing arms connected to the frame. The frame and the pair of opposing arms define a generally C-shaped variably sized interior space depending on the positions of the arms. Each arm is horizontally moveable relative to the frame such that the arms can move inward toward each other and outward away from each other. Each arm comprises a lifting pad on or near a bottom of the arm and configured to fit underneath the rack on a side of the rack. Each arm also comprises an inward-facing surface configured to snugly contact or be nearby a side of the rack when the arms are in a closed position.

Each arm also optionally comprises a load stop along an edge of the arm distal from the frame. The load stops are configured to inhibit tipping of the rack away from the frame.

The clamp optionally further comprises one or more actuators (e.g., electric actuators) connected to the frame and to each of the arms and configured to cause the arms to move horizontally inward and outward.

According to one embodiment, the inward-facing surfaces are padded.

According to one embodiment, each arm further comprises a back stop proximate to the frame.

According to one embodiment, each arm is L-shaped, wherein the lifting pad is the bottom base of the L.

According to one embodiment, the clamp is moveable between an open position and a closed position. The open position is characterized by an opening at the distal end greater than a width of the rack. The closed position is characterized by the inner surfaces approximately matching the width of the rack.

The clamp optionally further comprises one or more rack-aligning tabs extending distally from the distal side of the each arm, the rack-aligning tabs configured to urge a rack into alignment with the clamp by contacting a side or corner of the rack. The rack-aligning tabs may optionally comprise padding on an inward-facing surface of rack-aligning tabs.

According to one embodiment, the electronic equipment is computer server equipment.

According to one embodiment, the lifting pad on each arm protrudes toward the opposite arm.

According to one embodiment, the lifting pad on each arm protrudes toward the frame; the frame further comprises a fixed lifting pad near a bottom of the frame and configured to fit underneath the rack on a side of the rack; and each arm has an adjustable reach, such that the lifting pad on each arm is movable.

According to one embodiment, each arm comprises an electric actuator configured to move a distal end of its arm further and closer to the frame.

According to another embodiment, a materials-handling vehicle comprises a vertically moveable mast, a carriage connected to the vertically moveable mast, and a clamp connected to the carriage. The clamp is configured to lift and carry a rack housing electronic equipment. The clamp comprises a frame connected to a vertically moveable mast of the materials-handling vehicle and a pair of opposing arms connected to the frame. Each arm is horizontally moveable relative to the frame such that the arms can move inward toward each other and outward away from each other. Each arm comprises a lifting pad on or near a bottom of the arm and configured to fit underneath the rack on a side of the rack, an inward-facing surface configured to snugly contact or be nearby a side of the rack when the arms are in a closed position, and a load stop along an edge of the arm distal from the frame, the load stops configures to inhibit tipping of the rack away from the frame.

According to one embodiment, the carriage is configured to tilt, swivel, or twist.

According to one embodiment, the vehicle may be, for example, a counterbalanced sit-down lift truck or a moving mast tugger.

According to one embodiment, the materials-handling vehicle may optionally further comprise a sensor positioned and configured to detect a presence of the rack. According to one embodiment, the sensor is positioned on the mast, below the mast, on the carriage, or on the clamp.

According to one embodiment, the clamp is removeable from the carriage.

According to one embodiment, the clamp is configured to carry the rack oriented with longer sides of the rack parallel to the frame and shorter sides of the rack parallel to the arms.

According to another embodiment, the clamp is configured to carry the rack oriented with shorter sides of the rack parallel to the frame and longer sides of the rack parallel to the arms.

According to yet another embodiment, a method moves a rack of electronic equipment in a data center using a materials-handling vehicle comprising a mast and a clamp connected to the mast on one side of the materials-handling vehicle, wherein the clamp comprises two opposing arms. The method comprises driving the materials-handling vehicle to a position such that the clamp faces the rack, opening the clamp into an open position characterized by the opposing arms of the clamp separated by a distance that exceeds a width of the rack, driving the materials-handling vehicle such that the rack is within the opposing arms of the clamp, closing the clamp into a closed position such that the opposing arms of the clamp snugly contact opposite sides of the rack, and lifting the clamp and thereby the rack therein. The method also comprises driving the materials-handling vehicle proximate to a desired position of the rack in the data center, lowering the clamp and thereby the rack therein until the rack is on a floor, opening the clamp into the open position, and driving the materials-handling vehicle, sans the rack, to a displace the clamp from the rack.

According to one embodiment, the method further comprises extending the lengths of the arms such that the distal ends of the arms extend beyond the distal side of the rack before closing the clamp into the closed position and shortening the lengths of the arms after closing the clamp into the closed position and before lifting the clamp and thereby the rack.

According to one embodiment, the rack comprises new or refurbished electronic equipment, an initial position of the rack is a lorry or loading area, and the desired position is an operational position within the interior of the data center.

According to one embodiment, the rack is on a pallet in its initial position.

According to one embodiment, the rack comprises used or broken electronic equipment, an initial position of the rack is an operational position within the interior of the data center, and the desired position is a lorry or loading area.

### Example Embodiments Illustrated in the Drawings

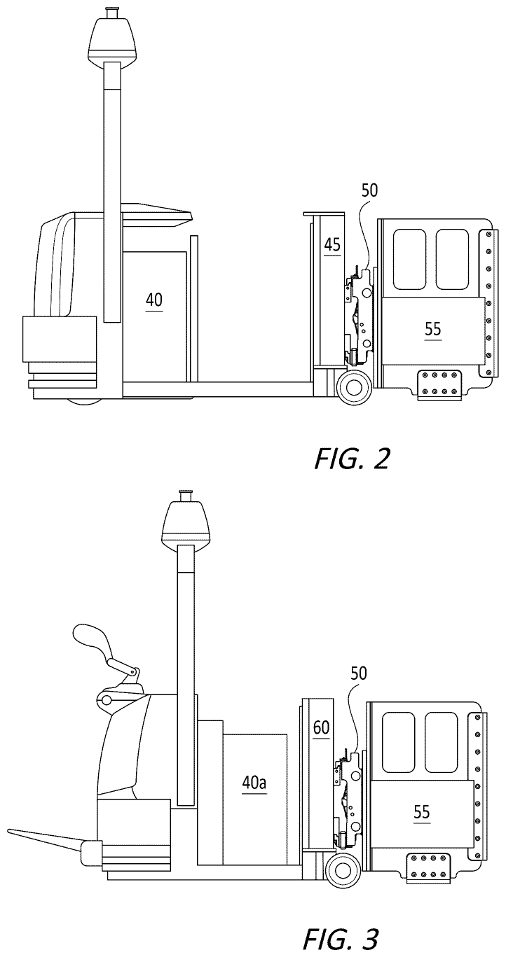

FIGS. 2 and 3 illustrate an example moving mast tugger 40 with a mast 45 bearing a carriage 50 connected to a clamp 55, and a counterbalanced stacker 40a with a mast 60 bearing a carriage 50 connected to the clamp 55, respectively. Other suitable vehicles may be used with the clamp 55 for moving a server rack 5. Additionally, instead of a carriage 50, other suitable connection mechanisms between a vehicle and the clamp 55 may be used such as a pantograph mechanism or other suitable mechanism for lifting the clamp 55. The connection between the vehicle and clamp 55 is constructed to lift the clamp 55 and to lower the clamp 55 with respect to the surface on which the vehicle drives. Optionally, the connection between the vehicle and the clamp 55 may also tilt, swivel, twist, or horizontally translate the clamp 55, for example, to align the clamp 55 with a server rack 5 for engaging and picking up the server rack 5.

The clamp 55 and other clamps described herein may be removably attachable to a suitable vehicle with lifting capability, such as the mast tugger 40, counterbalanced forklift truck, or other suitable vehicle. Alternatively, the clamp 55 and other clamps described herein may be permanently attached to or built into a dedicated clamp lift vehicle. That is, the clamp may be integrated into the vehicle. The clamp may be mounted or attached to the front of the vehicle or rear of the vehicle.

As shown in FIGS. 2 and 3, the right side will be referred to as the “front,” “distal,” or “far” side or end of the clamp, while the left side, as illustrated here, will be referred to as the “back,” “proximal,” or “near” end or side of the clamp, regardless of which way the vehicle is driven in its “forward” direction.

The inventions described herein can clamp and carry racks of varied sizes, shapes, and contents. The embodiments described herein are presented and explained with reference to a rack that houses computer server equipment, as would be found in a server farm or data center, but that is just an example for the sake of illustration. That is, the server rack 5 is just an example for the sake of illustration. Server racks may come in standard or de facto standard sizes, such as approximately 24 inches (600 mm) wide, 42 inches (1066.8 mm) deep, and 73.6 inches (1866.9 mm) tall. Other typical server rack widths are approximately 29.5-inch (750 mm) and 31.5-inch (800 mm). Other typical server rack depths are approximately 29 inches (736.6 mm), 36 inches (914.4 mm), 50 inches (1270 mm), and 59 inches (1500 mm). Other typical server rack heights are approximately 38.5 inches (977.9 mm47), 47.25 inches (1200.15 mm), 84 inches (2133.6 mm), and 105 inches (2667 mm). Server racks currently come in full height or half height variations. Double (e.g., double-wide) server racks are also possible.

The server rack 5 may be empty, full of electronic/computer equipment, or partially full of equipment when it is clamped and moved. When full, the server rack may currently weight as much as about approximately 3000-4000 pounds (1360.8-1814.4 kg). Heavier racks are anticipated in the future. The clamp and vehicle described herein may be designed to handle these weights.

The server rack 5 has a lifting area or lifting plate on the bottom along the edges of the short sides of the server rack 5. The clamp 55 is therefore designed to have lifting pads or lifting hooks in areas that can be located under the rack's lifting areas/plates when the clamp is properly positioned to lift and carry the server rack 5, as explained in more detail below. The bottom side of the server rack 5 also typically has feet, adjustment pins, and/or wheels near each corner. As will be explained more below, the lifting pads/hooks of the clamp 55 are designed and positioned to avoid those features on the bottom of the server rack 5.

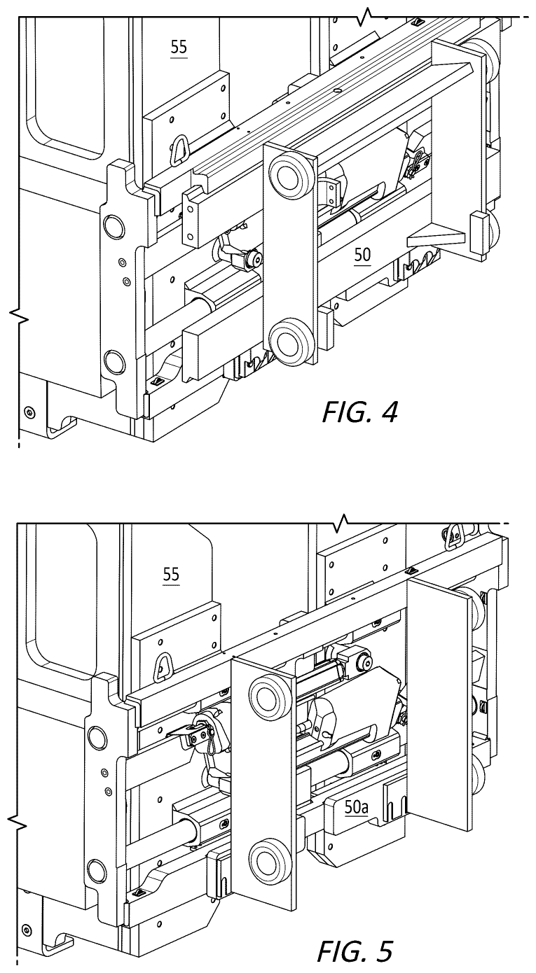

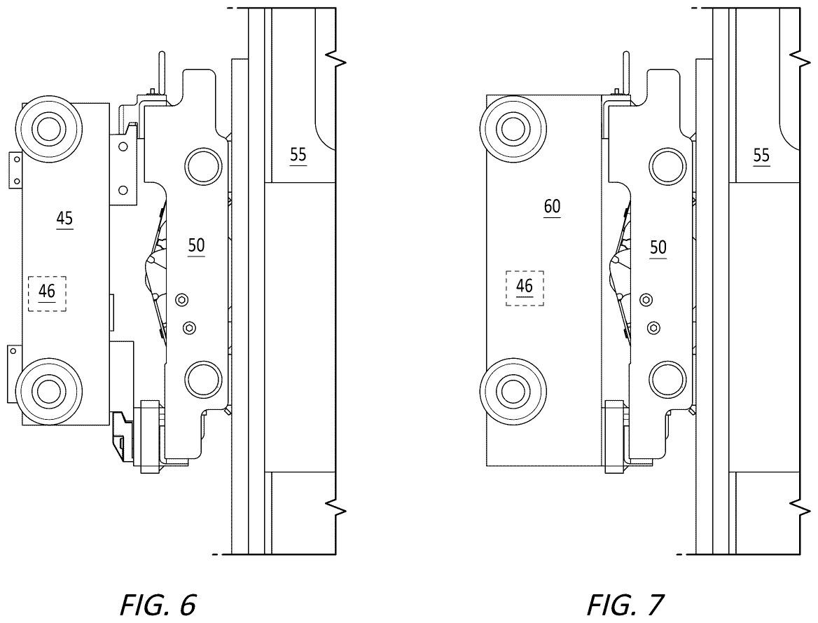

FIGS. 4 and 5 illustrate example carriages connected to a clamp 55, where the example carriages 50 and 50a are constructed to engage a mast, such as masts 45 or 60. FIG. 6 shows a side view of mast 45 bearing a carriage 50 with the carriage 50 attached to a clamp 55. FIG. 7 shows a side view of a mast 60 bearing carriage 50 with a carriage 50 attached to a clamp 55. In some embodiments, a sensor 46 may be disposed on a front of the vehicle, such as disposed on the mast 45 or 60, below the mast 45 or 60, on the clamp 55, or the like. Examples of the sensor 46 include a light detection and ranging (LIDAR) sensor, rangefinder, depth sensor, or the like. The sensor 46 may be configured to scan a server rack 5. The sensor 46, a controller of the vehicle, or other controller may be configured to determine a position and/or orientation of the server rack 5 in response to the scan of the server rack 5. The clamp 55 may be moved in response to the sensor 46, such as in response to the position and/or orientation of the server rack 5 determined in response to the scan. Although one sensor 46 is illustrated, multiple sensors 46 may be included and used to refine the position and orientation of the rack to allow the truck to determine position and/or orientation with higher precision, used to confirm a position and/or orientation determined in response to a single sensor 46, or the like.

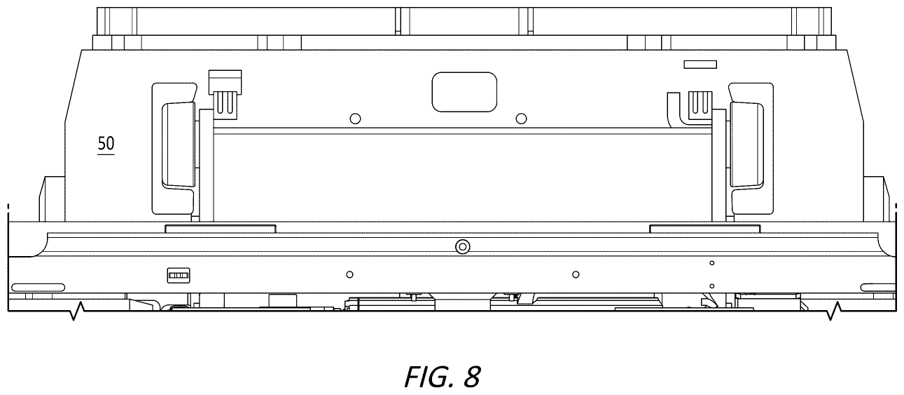

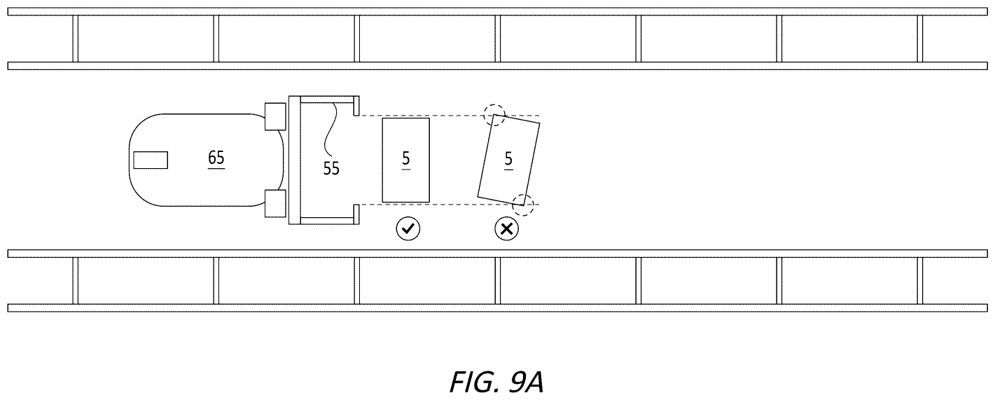

FIG. 8 illustrates an example carriage 50 that is constructed to engage with C-section channels of a mast and includes tilted load rollers for engaging the C-section channels.

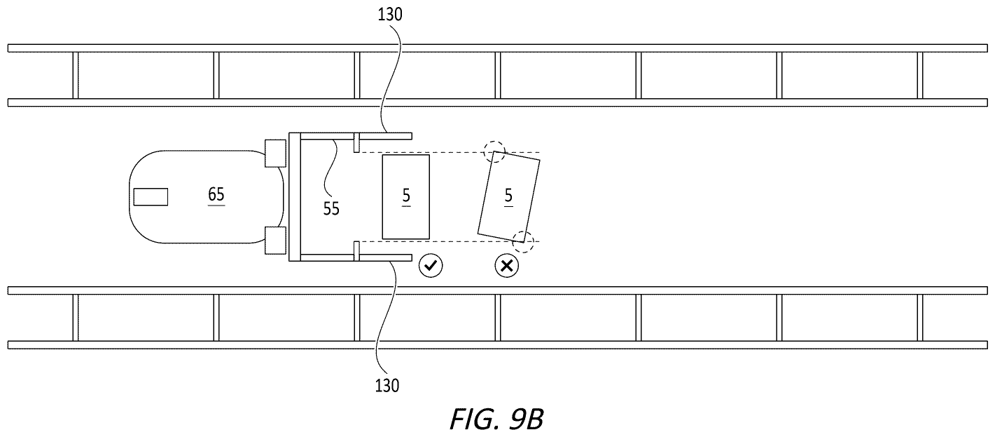

With reference to FIG. 9A, an example vehicle 65 bearing a clamp 55 approaches a server rack 5 in an aligned position, indicated by the check mark. With such an aligned position, the vehicle 65 may move straight forward to engage the clamp 55 with the server rack 5 for pick up, as explained in detail below. However, if the server rack 5 is in a misaligned position, for example rotated by +/−about 10 degrees with respect to a longitudinal axis of the clamp 55, indicated by the X, it may not be possible for the vehicle 65 to engage the server rack 5 with the clamp 55 by moving straight forward. In some embodiments, an operator of the vehicle 65, or the vehicle 65 itself if it is an automated guided vehicle, may need to maneuver the vehicle 65 to align the clamp 55 with the server rack 5 into a relationship such as shown between the clamp 55 and the rack 5 with the check mark. In other embodiments, the connection between the vehicle 65 and the clamp 55 may be constructed such that the clamp 55 is able to twist or swivel with respect to the body of the truck 65 such that the clamp 55 can be aligned with a server rack such as the server rack 5 indicated with the X, thus enabling the vehicle 65 to move straight forward and engage and pick up a misaligned server rack 5, such as the server rack 5 indicated with the X.

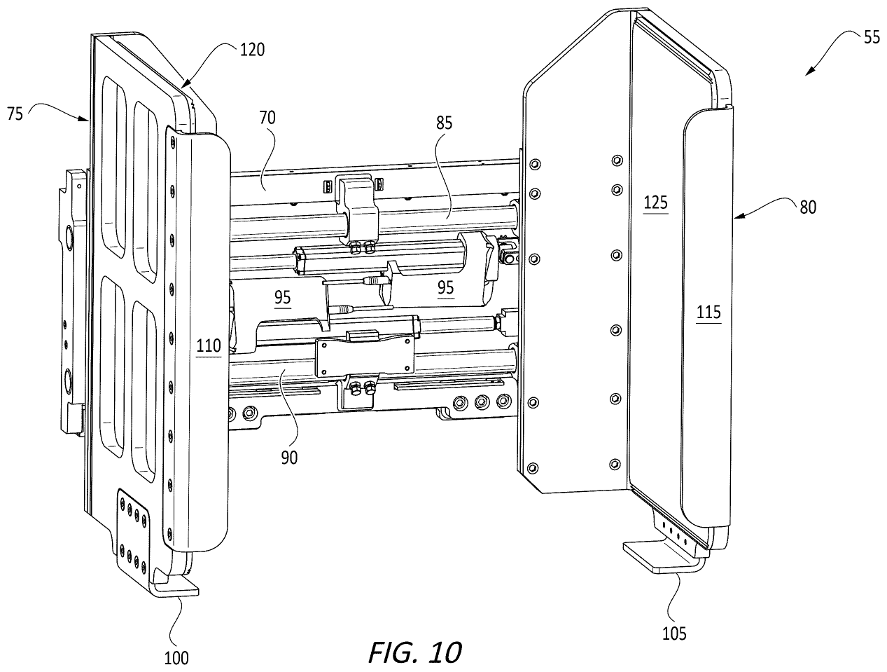

An example clamp 55 for engaging and picking up and moving a server rack 5 is described with respect to FIG. 10. The clamp 55 comprises a frame 70 for supporting the components of the clamp 55. A right arm 75 and a left arm 80 are slidably mounted on the frame 70, for example on an upper bar 85 and a lower bar 90. Other suitable sliding mechanisms may be used. In the example illustrated in FIG. 10, electric actuators 95 are connected to the right arm 75 and to the left arm 80. For example, one actuator is connected to the right arm 75 while the other actuator is connected to the left arm 80 for moving the right arm 75 and the left arm 80 towards and away from each other.

A lifting pad 100 is secured to the right arm 75 and a lifting pad 105 is secured to the left arm 80. Lifting pads 100 and 105 are shaped and sized to fit underneath a server rack 5 and to engage an underside of the server rack 5 for lifting, carrying and lowering the server rack 5. Optional load stops, such as load stop 110 attached to right arm 75 and load stop 115 attached to left arm 80, may be included on the clamp 55 to inhibit a server rack from tipping forward out of the clamp 55 when being carried, for example, when a vehicle makes a sudden stop. Another option for the clamp 55 is to include a padded surface 120 on right arm 75 and a padded surface 125 on left arm 80 to cushion a server rack while being lifted, carried, and lowered. The padded surfaces 120 and 125 may be, for example, rubber, foam, or the like. The padded surfaces 120 and 125 may be continuous or spaced-apart parallel strips of padded material arranged horizontally and/or vertically.

The size and dimensions of the clamp 55 can be varied to accommodate the expected size of the racks that the clamp 55 is intended to carry. According to one example, suitable for use with current typical server racks, the arms 75 and 80 have a height of approximately one-third to one-half the height of the rack 5; the lifting pads 100 and 105 are extend approximately 35 mm under the rack 5; and the load stops 110 and 115 extend approximately 80% to 100% of the height of the arms 75 and 80. Alternatively, the load stops 110 and 115 may be substantially shorter and located at or near the top of the arms 75 and 80.

The electric actuators 95 may be linear actuators, but other suitable mechanisms may be used such as a ball and screw actuator, hydraulic cylinders, cables and pulleys, or other suitable devices for moving the right arm 75 and the left arm 80 towards and away from each other. Alternately, a single actuator may be used for moving the right arm 75 and the left arm 80 towards and away from each other. In one embodiment, the arms 75 and 80 move together and apart in unison, in which case a single actuator may be employed. In another embodiment, the left arm 75 and the right arm 80 move independently, such as each with a dedicated actuator. Independent movement of the arms can be useful when the vehicle is not laterally centered relative to the server rack 5 as the vehicle approaches the server rack 5. In that case, moving one of the left arm 75 or the right arm 80 more than the opposite arm can simplify clamping of the server rack 5.

Except where otherwise indicated, the primary structural parts of the clamp 55 (e.g., the frame 70, arms 75 and 80, bars 85 and 95, lifting pads 100 and 105, and load stops 110 and 115) are preferably solid metal, such as steel, although other appropriate materials may be used.

The right arm 75 and/or the left arm 80 of the clamp 55 may optionally include one or more rack-aligning tabs 130 that extend forward from the front end(s) of the side arms 75 and 80, as shown in FIG. 9B. If included, such tabs 130 can be used to grab the rack 5 and move it into a desired position without clamping and lifting it (i.e., by causing the wheels of the rack 5 to roll on the floor of the data center 5). For example, before clamping and lifting the rack 5, it may be desirable to rotate the rack 5 into better alignment with the clamp 55 or to cause translational movement to a better location for clamping and lifting (e.g., away from a possible overhead obstacle). Movements such as these can be effectuated with the aid of a counterbalanced truck 65 by bringing the truck 65 into proximity of the rack 5, as would be done to clamp and lift the rack 5, but stopping short so that only the tabs 130 are within reach of the rack 5. Then, moving the right arm 75 and the left arm 80 together causes the tabs 130 to contact the rack, at which point turning or driving the counterbalanced truck will move the rack 5. In some cases, just the act of moving the tabs 130 toward the center may cause the rack to rotate into a better aligned position, such as from the “X” position to the check-mark position illustrated in FIGS. 9A and 9B. The interior surfaces of the tabs 130 may be cushioned and/or padded to prevent damage to the rack 5. If so, the padding material may be same as used on the padded surfaces 120 and 125, or different. The tabs 130 may be removable or retractable. The tabs 130 may be approximately as long as or slightly longer than the length of the arms 75 and 80.

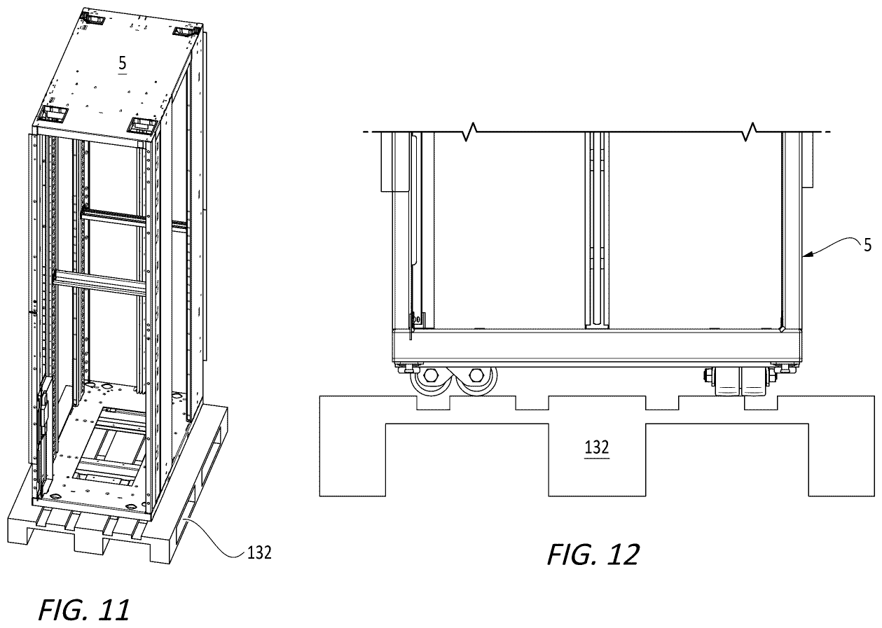

With reference to FIGS. 11-20, delivery of a server rack 5 containing computer equipment 10 to a data center 15 and moving the server rack 5 into its operating position is described. While the server rack 5 is described as being loaded on a pallet 132 before pick up, the server rack 5 may be on a floor platform or other surface and dropped off on a floor, pallet, platform or other suitable surface.

As illustrated in FIGS. 11 and 12, the server rack 5 (computer equipment 10 omitted for clarity) is delivered on a pallet 132 at a data center 15, for example at a loading dock. As seen in FIG. 12 there is an accessible space between the wheels of the server rack 5 and also between the bottom of the server rack 5 and the top of the pallet 132 on the short sides of the rack 5 (typically the front and rear sides of the rack 5). The lifting pad 100 and the lifting pad 105 of the clamp 55 are sized and constructed to fit into the accessible space between the wheels of the server rack 5 and between the server rack 5 and the top of the pallet 132. In the prior art, without the benefit of the invention, the server rack 5 would have been manually rolled off the pallet using a ramp (not shown). Such an operation was time-intensive, labor-intensive, and could sometimes result in accidently tipping the server rack 5.

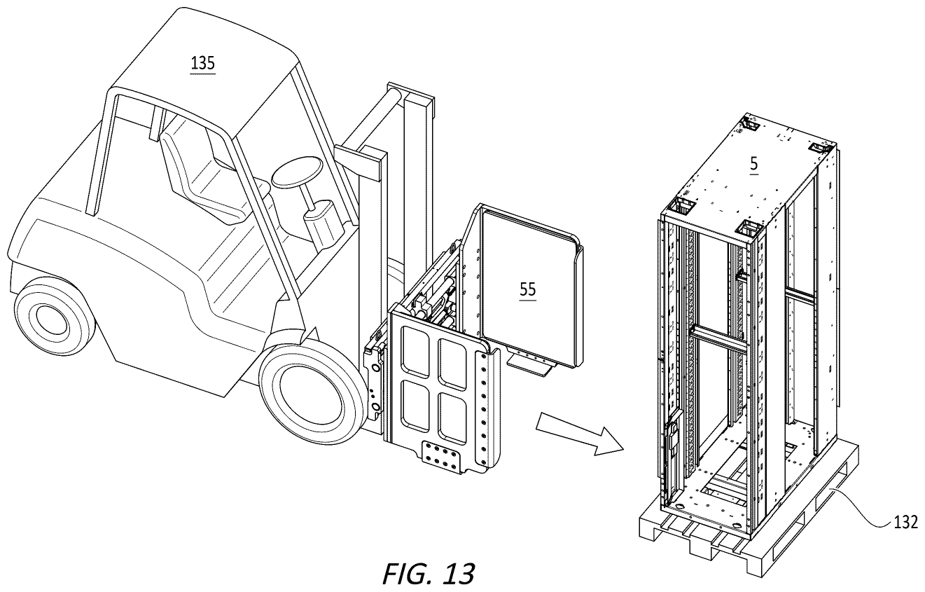

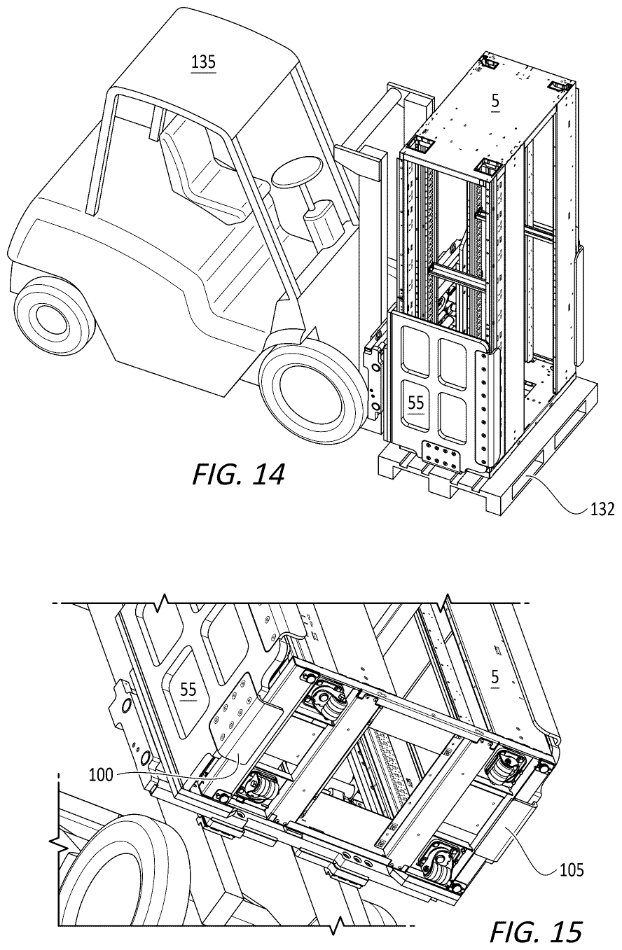

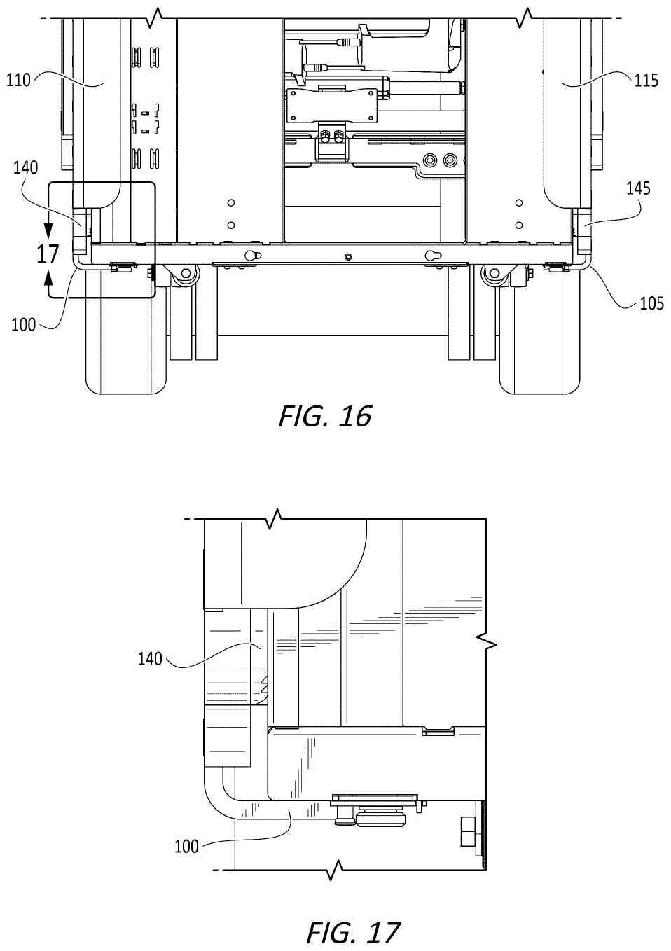

With reference to FIG. 13, a counterbalanced forklift truck 135 carrying a clamp 55 for up and down movement on a mast with respect to the floor of the data center 15 approaches the server rack 5 on the pallet 132. With the clamp 55 aligned with the server rack 5 either by maneuvering the counterbalanced truck 135 and/or twisting or turning the clamp 55 with respect to the body of the counterbalanced truck 135, the clamp 55 is moved into engagement with the server rack 5, as illustrated in FIG. 14. As seen in FIG. 15, the lifting pad 100 and the lifting pad 105 engage the underside of the server rack 5 as the clamp arm 75 and the clamp arm 80 are moved towards each other to encase the server rack 5 with the right arm 75 and the left arm 80. As the counterbalanced truck 135 lifts the clamp 55, the engagement between the lifting pad 100 and the lifting pad 105 and the underside of the server rack 5 allows the rack 5 to be lifted clear of the pallet 132 or other surface on which the server rack 5 rests. As illustrated in FIGS. 16 and 17, optional contact pads 140 and 145 engage sides of the server rack 5 to provide lateral stability for the server rack 5 as it is being carried by the clamp 55.

The lifting pads 100 and 105 provide support for the server rack 5 and any computer equipment 10 contained in the server rack 5. If included, pads 120 and 125 may enhance lateral stability for the server rack 5. Longitudinal stability for the server rack 5 may be provided by the back surfaces (which act as back stops) of the right arm 75 and the left arm 80 as well as optional load stops 110 and 115, if included.

The action of moving the arms 75 and 80 together and/or apart may be controlled manually by the operator of the vehicle or another person outside the vehicle. Alternatively, stopping motion of the arms 75 and 80 may be automated in various ways. For example, contact, proximity, and/or pressure sensors on one or both arms 75 and 80 may detect when the arm has contacted or nearly contacted the server rack 5 and stop the closing motion of the arms 75 and 80 when the arms 75 and 80 are in a desired position relative to the server rack 5.

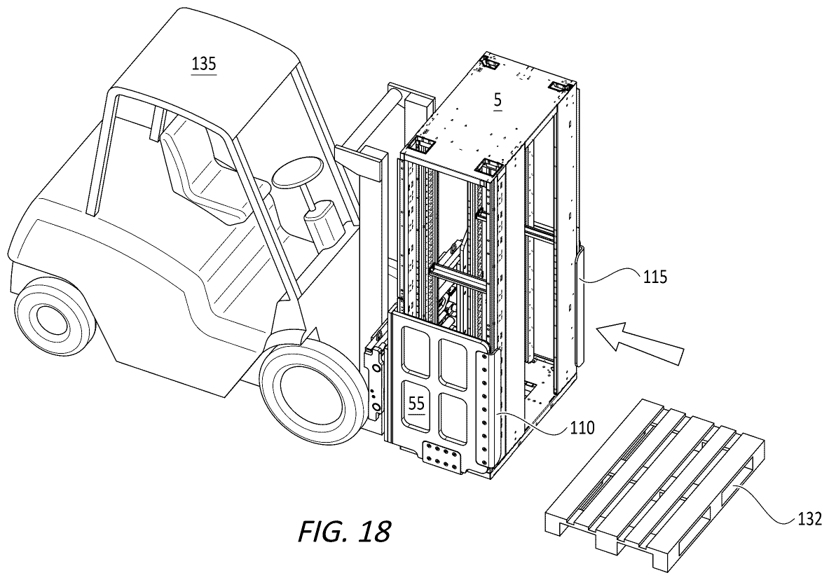

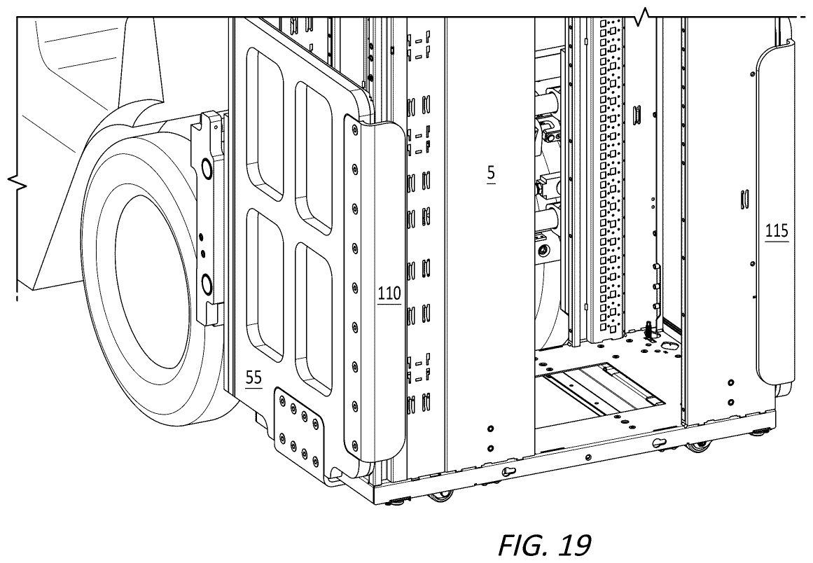

As illustrated in FIG. 18, once the server rack 5 has been lifted clear from the pallet 132, the counterbalanced truck 135 drives away from the pallet 132 and then drives through the data center 15 to bring the server rack 5 and its computer equipment 10 contained therein to its operational location within the data center 15. FIG. 19 illustrates longitudinal stability provided by optional load stops 110 and 115, which may inhibit the server rack 5 from tipping out of the clamp 55 if the counterbalanced truck 135 stops suddenly.

While traveling carrying the server rack 5, the clamp 55 and the server rack 5 may be carried at any desirable height above the floor, such as, for example, approximately 2-12 inches (50-305 mm), preferably approximately 6-10 inches (150-254 mm). While traveling carrying the server rack 5, the counterbalanced truck 135 may travel at any desirable speed, such as, for example, approximately about 6.4-9.7 mph (4-6 km/hr). The maximum speed while carrying the rack 5 may be limited; for example, the maximum speed may be approximately 5 miles per hour (8 km per hour).

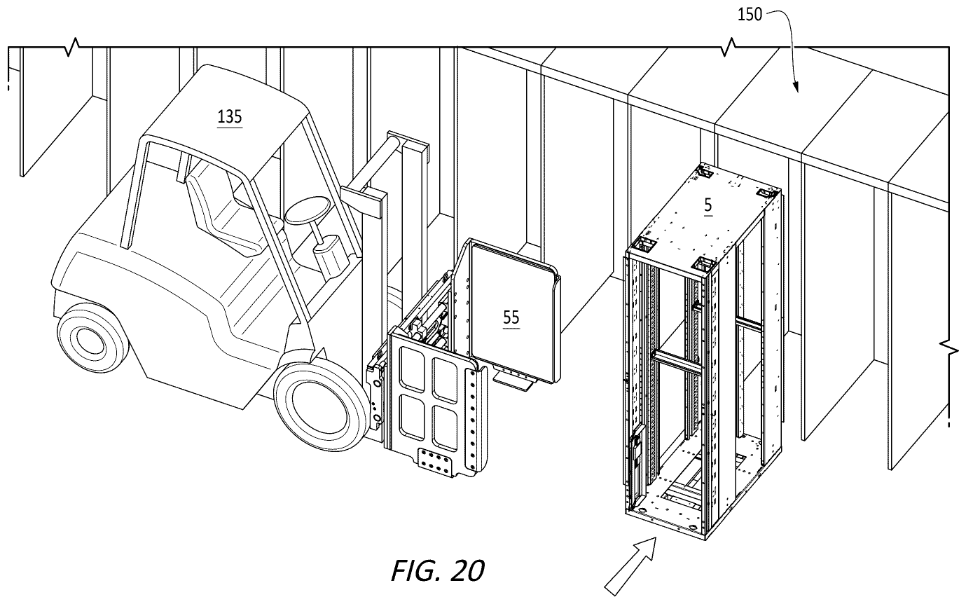

When the counterbalanced truck 135 connected to the clamp 55 carrying the server rack 5 and its associated computer equipment 10 arrives at the operational position for the server rack 5, the counterbalanced truck 135 is operated to lower the clamp 55 such that the wheels of the server rack 5 rest on the floor of the data center 15. Once the wheels of the server rack 5 are resting on the floor of the data center 15, the electric actuators 95 are operated to move the right arm 75 and the left arm 80 away from each other, thus removing the lifting pad 100 and the lifting pad 105 from underneath the server rack 5. Once the lifting pad 100 and the lifting pad 105 are clear of the sides of the server rack 5 and the optional load stop 110 and load stop 115, if included, are clear of the sides of the server rack 5, the counterbalanced truck 135 backs away from the server rack 5 leaving it on the floor at or near its operational position in the data center 15. Once the server rack 5 has been dropped off it may be manually pushed into its final position in a housing 150 using the wheels on the bottom of the server rack 5, if necessary, as illustrated in FIG. 20.

Removing a server rack 5 with computer equipment 10 that needs to be refurbished or recycled occurs in a reverse order to that just described above. For example, a server rack 5 is manually moved from its operating position in the housing 150 using the wheels on the bottom of the server rack 5. Once the server rack 5 is clear of the housing 150, a vehicle bearing a clamp 55 may position the clamp 55 such that lifting pads 100 and 105 engage the underside of the server rack 5 using the accessible lift space between the wheels of the server rack 5. The right arm 75 and the left arm 80 of the clamp 55 are then moved towards each other to place the lifting pads 100 and 105 underneath the server rack 5. Once the clamp 55 is closed such that the lifting pads 100 and 105 are underneath the server rack 5 and the right arm 75 and the left arm 80 engage the server rack 5 with a sufficient force to provide lateral stability, but not such a strong force as to damage the server rack 5, the interface between the clamp 55 and the counterbalanced truck 135, or other suitable vehicle, is operated to lift the server rack 5 off of the floor of the data center 15.

The server rack 5 is then driven to a desired location, such as a loading dock where the interface between the clamp 55 and the counterbalanced truck 135 is operated to set the server rack 5 down such that the wheels of the server rack 5 rest on the floor of the data center 15 or truck lorry. Electric actuators 95 are then operated to move the right arm 75 and the left arm 80 away from each other such that the lifting pad 100 and the lifting pad 105 are removed from underneath the bottom of the server rack 5 and clear the sides of the server rack 5 as well as clearing the right arm 75 and the left arm 80 from the sides of the server rack 5. The counterbalanced truck 135 may then be driven away from the server rack 5 which may be manually moved to a final position for loading onto a trailer or other transport, if necessary. If desired, the truck 135 may be driven into a lorry to drop off the rack 5 therein.

The example embodiments described above in this section and illustrated in FIGS. 2-20 involve a first example clamp 55 designed to lift and carry a server rack 5 in a first orientation in which one of the lateral (longer) sides of the server rack 5 is proximal to the frame 70, the carriage 50, the mast 45 or 60, and the truck 65 or 135; the opposite lateral (longer) side of the server rack 5 is distal from the same; and the front and rear (shorter) sides of the server rack 5 contact or are adjacent to the right and left arms 75 and 80. In saying so, it is assumed that the short sides of the server rack 5 are the front and rear sides, whereas the long sides of the server rack 5 are the lateral sides, as is typically the case with conventional racks, but it is also possible now or in the future that a server rack may be designed to have wide front and rear side and less wide lateral sides, and the invention described herein is equally applicable to such a rack.

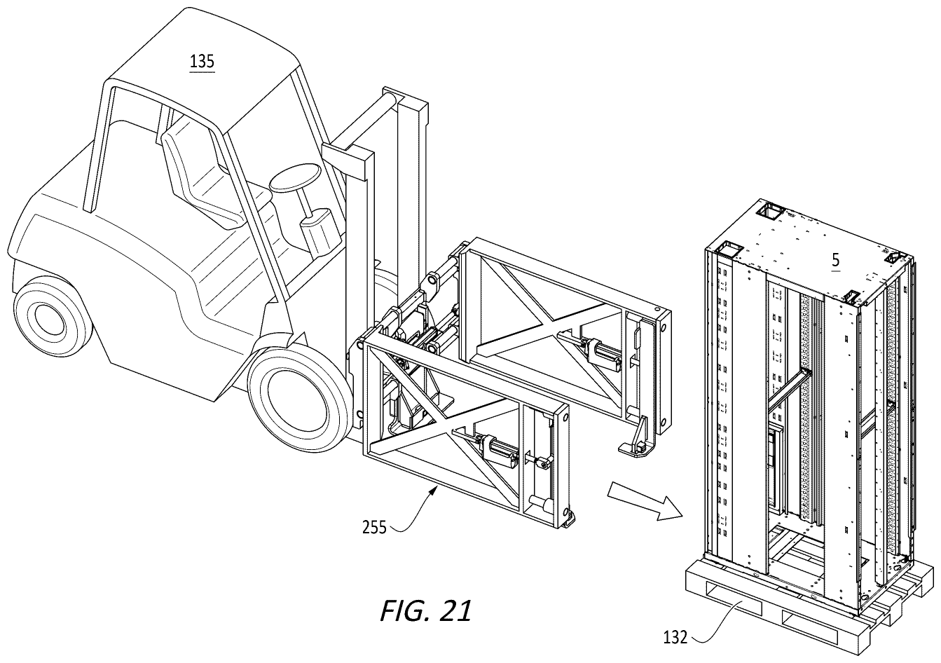

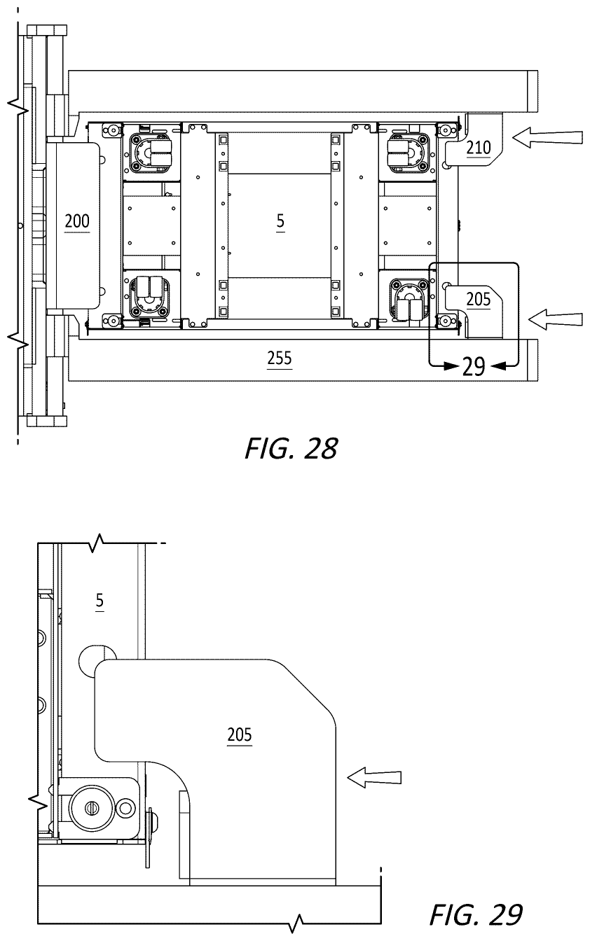

Next, an embodiment will be described in which a second example clamp lifts and carries a server rack in the transverse orientation as compared to the first example above. In this second example, the front or rear (less wide) sides of the server rack are parallel to the clamp's frame, and the lateral (wider) sides of the server rack are parallel to the clamp arms. This second example clamp is described as follows with reference to FIGS. 21-32.

FIG. 21 illustrates a counterbalanced forklift truck 135 carrying a clamp 255 for up and down movement on a mast with respect to the floor of the data center, as the truck 135 approaches a server rack 5 on a pallet 132 oriented with a narrow side (front or rear) of the server rack 5 facing the clamp 255. With the clamp 255 aligned with the server rack 5 in this way, either by maneuvering the counterbalanced truck 135 and/or twisting or turning the clamp 255 with respect to the body of the counterbalanced truck 135, the clamp 255 is moved toward and into engagement with the server rack 5, as illustrated in FIG. 21. As explained in more detail below, when the clamp 255 is positioned around the server rack 5 in this orientation, lifting pads near the bottom of the clamp 255 can engage the underside of the server rack 5 as the arms of the clamp 255 are moved so as to enable the server rack to be lifted and moved in the data center.

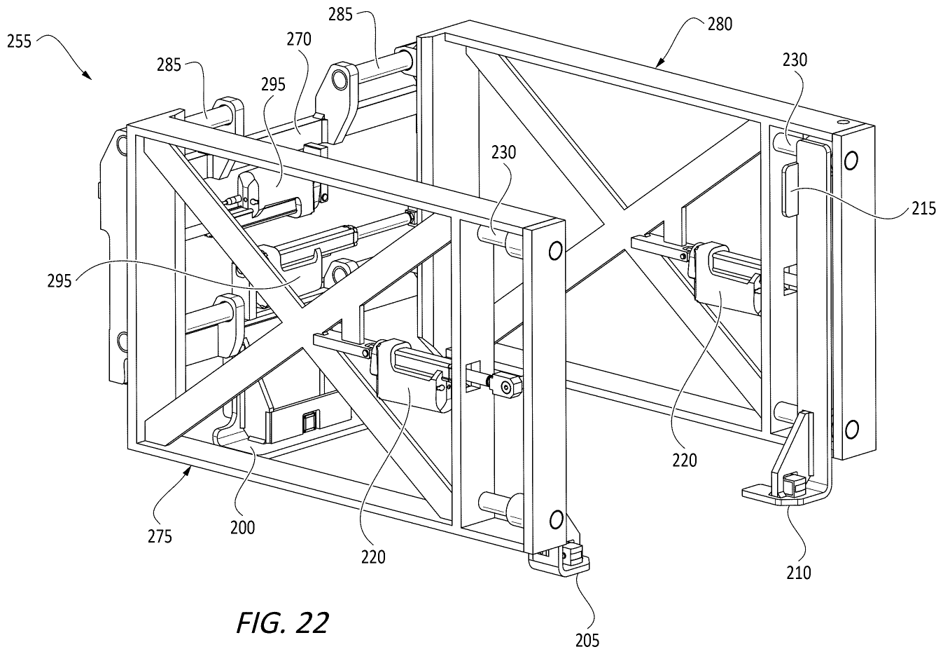

FIG. 22 illustrates the clamp 255 disconnected from the counterbalanced forklift truck 135. The clamp 255 comprises a frame 270 for supporting the components of the clamp 255. A right arm 275 and a left arm 280 are slidably mounted on the frame 270, for example on one or more upper bars 285 and/or one or more lower bar (not labeled). Other suitable sliding mechanisms may be used. In the example illustrated in FIG. 22, one or more electric actuators 295 are connected to the right arm 275 and/or to the left arm 280. For example, one actuator is connected to the right arm 275 while another actuator is connected to the left arm 280 for moving the right arm 275 and the left arm 280 towards and away from each other.

A fixed lifting pad or hook 200 is secured near the bottom of the frame 270 extending inward toward the interior space defined by the generally C-shaped combination of the clamp frame 270 and right and left arms 275 and 280. The fixed lifting pad/hook 200 is positioned to fit under the server rack 5 in an area corresponding to a lifting plate on the bottom of the server rack 5. For example, the fixed lifting pad/hook 200 may be centered laterally on the frame 270, as shown in the drawings.

Two movable lifting pads or hooks are located near the distal ends of the arms on or near their bottoms. As shown in the drawings, a right movable lifting pad/hook 205 is on the right arm 275, and a left movable lifting pad/hook 210 is on the left arm 280. The movable lifting pad/hooks 205 and 210 extend in the proximal direction inward into the generally C-shaped interior space of the clamp from respective bases that extend laterally inward from their arms. The movable lifting pad/hooks 205 and 210 are located such that when the arms are laterally separated and opened sufficiently, the distance between the movable lifting pad/hooks 205 and 210 at their bases is greater than the narrower side dimension of the server rack 5. The movable lifting pad/hooks 205 and 210 are also located such that when the arms are closed around a server rack 5, the movable lifting pad/hooks 205 and 210 can be positioned under lifting plates on the bottom of the server rack 5. The movements of the clamp 255 to achieve that lifting position are described in more detail below.

Optional load stops, such as load stop 215 attached to left arm 280, may be included on the clamp 255 to inhibit the server rack 5 from tipping out of the clamp 255 when being carried, for example, when the truck 135 makes a sudden stop. Padded surfaces may be provided on interior surfaces of the arms 275 and 280, the frame 270, and/or the load stops, if included, to cushion a server rack while being lifted, carried, and lowered. Padded surfaces may also be provide on tops surfaces of the lifting pads 200, 205, and 210.

The adjustable part of the arms 275 and 280 may be just the portion of the arms 275 and 280 including the movable lifting pad/hooks 205 and 210 and the load stops (i.e., the left arm stop 215 and a corresponding right arm load stop). Alternatively, more of the arms 275 and 280 may be adjustable.

One or more electric actuators 295 are provided on or near the frame 270 to move the right arm 275 and the left arm 280 towards and away from each other. Each clamp arm 275 and 280 also carries one or more electric actuators 220 to move the movable lifting hooks 205 and 210 towards and away from the frame 270. The actuators may be linear actuators, but other suitable mechanisms may be used such as a ball and screw actuator, hydraulic cylinders, cables and pulleys, or other suitable devices.

The right arm 275 and/or the left arm 280 of the clamp 255 may optionally include one or more rack-aligning tabs, like the tabs 130 shown in FIG. 9B, to nudge the server rack 5 into a desired position without clamping and lifting it (i.e., by causing the wheels of the sever rack 5 to roll on the floor).

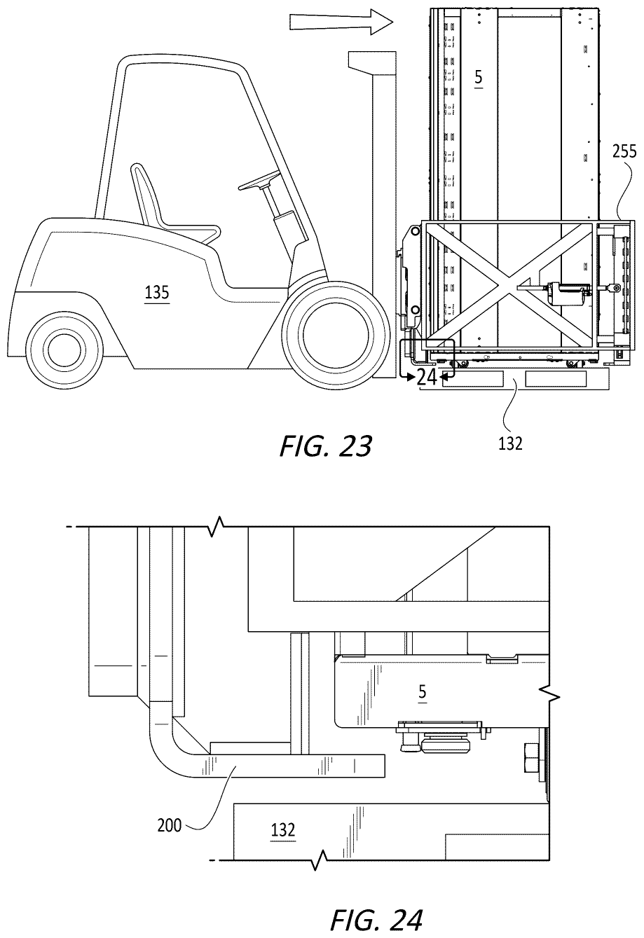

FIGS. 23-29 illustrate the sequence of operations of the truck 135 and the clamp 255 to lift the server rack 5 oriented with one of its narrow sides facing the open side of the clamp 255. First, assuming the truck 135 is sufficiently aligned with the server rack 5 in this orientation, the truck 135 is driven toward the server rack 5 with the clamp arms 275 and 280 sufficiently separated such that all parts of the arms 275 and 280, including the movable lifting pads 205 and 210, fit around the server rack 5, as illustrated in FIG. 23. This driving operation occurs with the clamp at an appropriate vertical height, such that the bottom of the clamp 255 is slightly above the pallet 132. The truck 135 stops when the fixed lifting pad 200 is positioned under the closest side of the server rack 5, specifically under a lift plate on the bottom of the server rack 5, as illustrated in FIG. 24. The fixed lifting pad 200 may extend, for example, about 35 mm beyond the near bottom edge of the server rack 5. The truck 135 may be manually driven to reach that desired position. Alternatively, an auto-stop feature may be employed to stop the truck when the desired position is reached. For example, a proximity sensor or contact sensor on the frame 270 may trigger stopping of the truck 135 in the desired position.

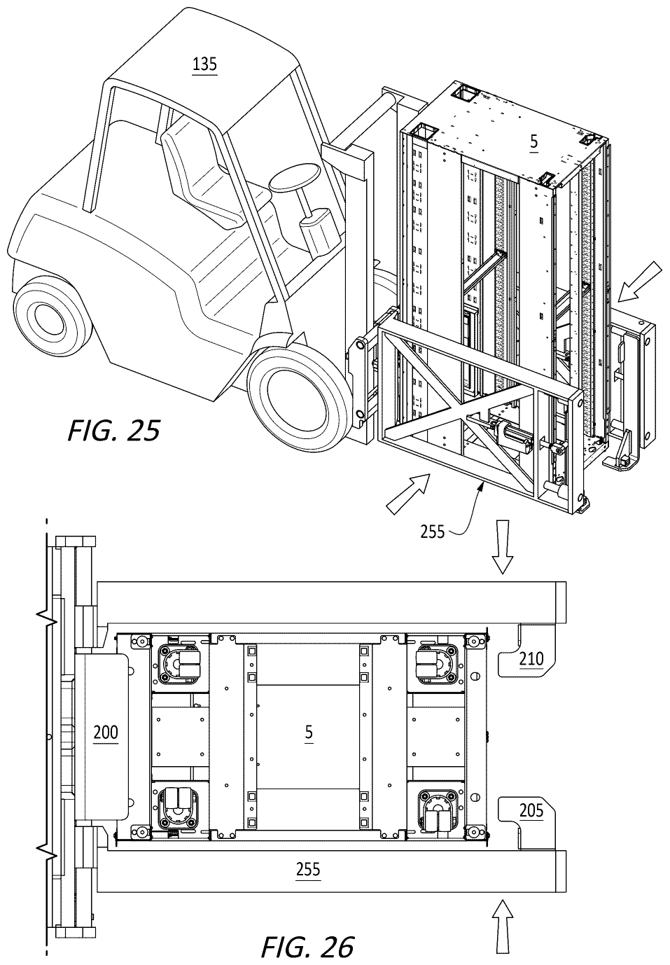

Next, if necessary, the movable hook actuators 220 are engaged to extend the lifting pads 205 and 210 along the lengths of the arms 275 and 280 such that the movable lifting pads 205 and 210 are positioned proximally away from the far side of the server rack 5. Then, as illustrated in FIGS. 25 and 26, the arms 275 and 280 are moved together towards the server rack 5, preferably not touching or barely touching the server rack 5 but not exerting any appreciable squeezing force on the server 5. That movement may be controlled manually or with an automatic shutoff.

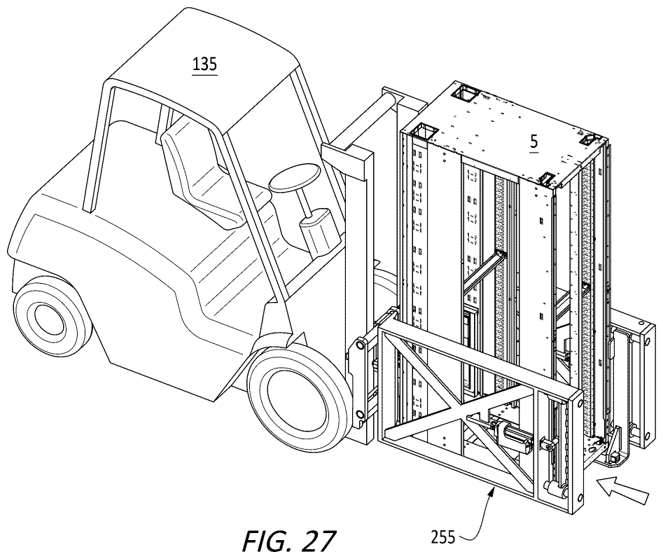

Next, as illustrated in FIGS. 27-29, using the movable hook actuators 220, the distance of the lifting pads 205 and 210 on the arms 275 and 280 is shortened with respect to the fixed lifting pad 200 to bring the movable lifting pads 205 and 210 under the server rack 5, specifically under a lifting plate on the bottom of the server rack 5. The movable lifting pads 205 and 210 may extend, for example, about 35 mm beyond the far/distal bottom edge of the server rack 5. This shortening motion of moving the lifting pads 205 and 219 along the arms 275 and 280 using the movable hook actuators 220 may be controlled manually or with an automatic shutoff. At this point, the clamp 255 is in position to lift the server rack 5. As the counterbalanced truck 135 lifts the clamp 255 the engagement between the lifting pads 200, 205, and 210 and the underside of the server rack 5 allows the sever rack 5 to be lifted clear of the pallet 132 or other surface on which the server rack 5 rests.

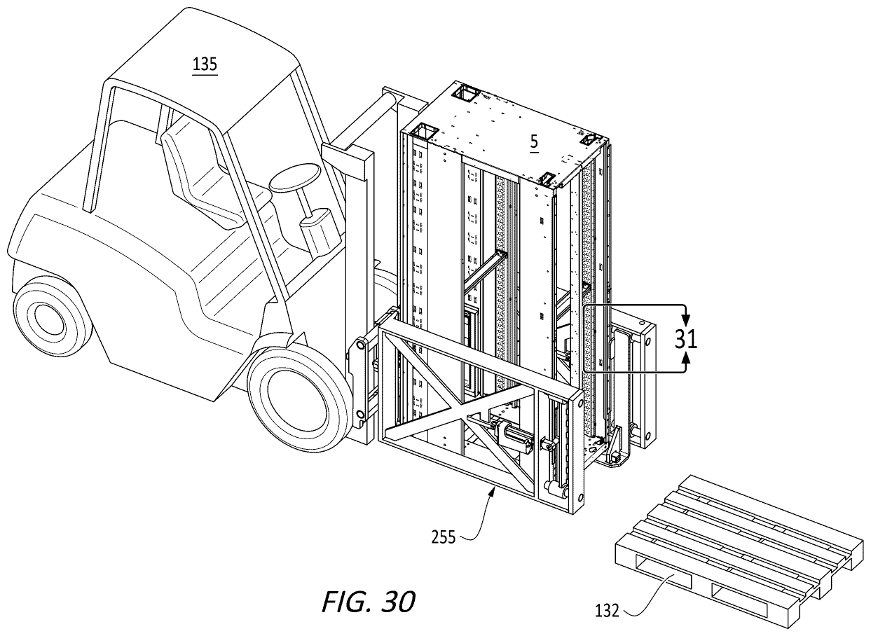

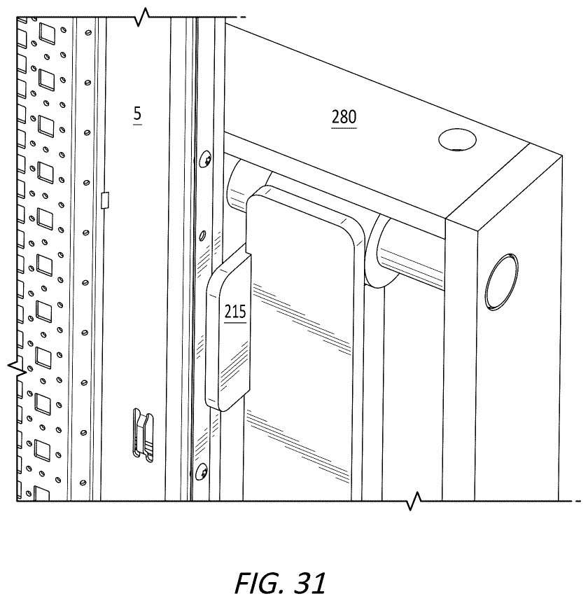

As illustrated in FIGS. 30 and 31, the counterbalanced forklift truck 135 drives carrying the server rack 5 on/in the clamp 255. Optional load stops 215 stabilize the server rack 5 to prevent tipping due to acceleration and/or deceleration of the truck 135 (depending on the direction).

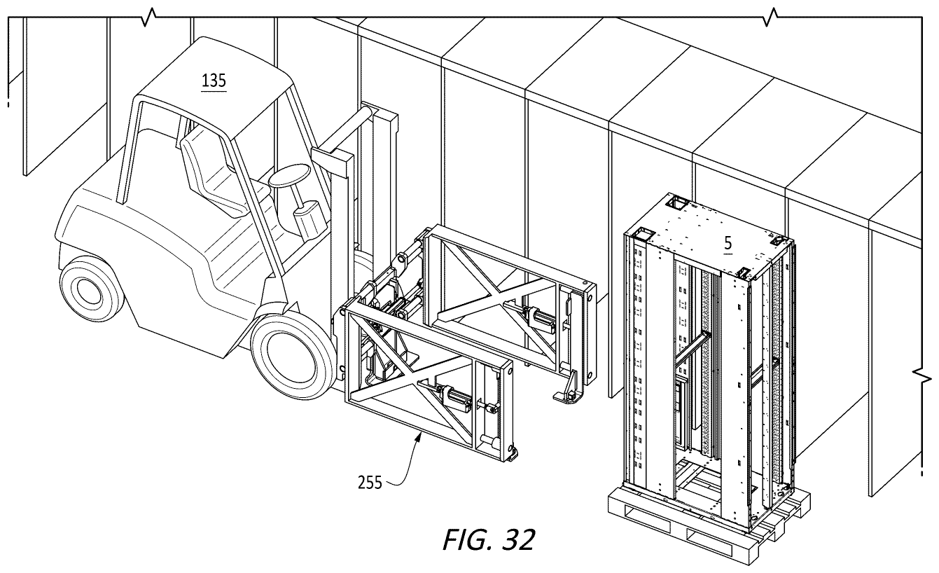

After transporting the server rack to its desired drop-off location, the server rack is dropped off by the following steps. First, the clamp 255 and server rack 5 are lowered until the server rack rests on the floor. Second, the distance of the lifting pads 205 and 210 on the arms 275 and 280 is lengthened with respect to the fixed lifting pad 200 using the movable hook actuators 220 so that the movable lifting pads 205 and 210 are clear of everything on or near the bottom of the server rack 5, including feet, wheels, etc. to be moved away laterally. Third, the arms 275 and 280 are moved away from each other laterally to an extent that all parts of the arms 275 and 280 (particularly the moveable lifting pads 205 and 210 and their associated bases) are spaced apart more than the narrow side width of the server rack 5. Fourth, the truck 135 is driven away from the server rack 5 removing fixed lifting pad 200 from underneath the server rack 5. As shown in FIG. 32, for example, the truck 135 is driven in reverse away from the set-down server rack 5. Steps 1-3 are intended to expand the clamp 255 such that all of its parts are clear of the server rack 5 so that step 4 can be undertaken. At this point, the server rack 5 can be manually rotated and pushed into its final position in a row of server racks, for example.

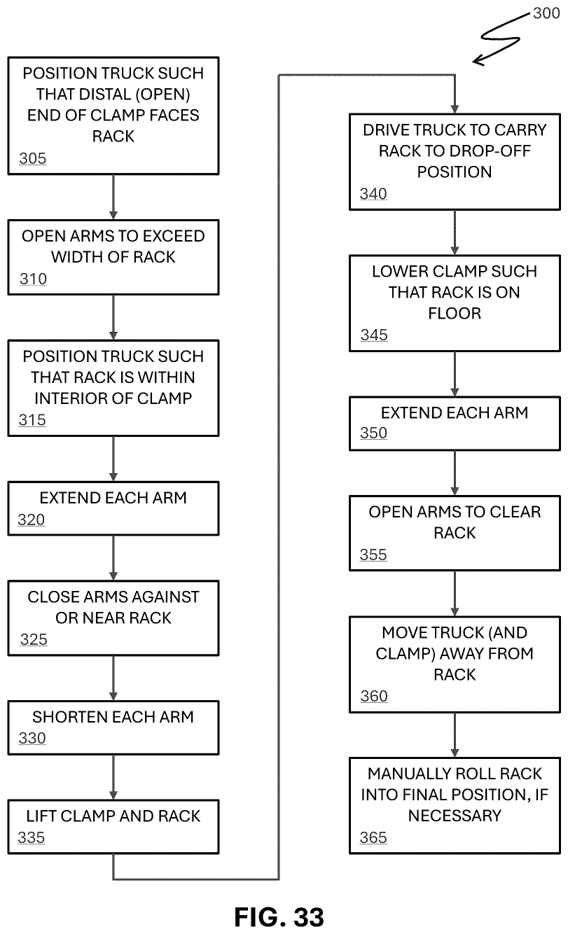

FIG. 33 is a flowchart illustrating one sequence of operations using the clamps described herein to move a rack of electronic equipment, according to a method 300. The following explanation of FIG. 33 is provided using the server rack 5, counterbalanced forklift truck 135, and the clamps 55 and 255 as examples, but the method is not limited to those items.

First, at step 305, the truck 135 is positioned so that the distal, open end of the clamp 55/255 faces the rack 5. If necessary, the height of the clamp 55/255 is adjusted such that the lifting pads proximate the bottom of the clamp 55/255 are slightly below the bottom of the rack 5. If the rack 5 is on a pallet, then the lifting pads proximate the bottom of the clamp 55/255 should be slightly above the top of the pallet. Next, at step 310, the left and right arms of the clamp 55/255 are opened to a width sufficient to perform the following step 315. At step 315, the truck is positioned such that the rack 5 is within the generally C-shaped interior of the clamp 55/255. If using the clamp 255, then the fixed lifting pad 200 should be under the rack at this point. If using the clamp 255, then step 320 is performed next; if using the clamp 55, step 320 is skipped. At step 320, each lifting pad is extended along its respective arm such that all parts of the distal ends of the arms, including the lifting pads, are beyond the far side of the rack 5.

At step 325, the arms of the clamp 55/255 are closed together against the rack or nearly against the rack. If using the clamp 55, the lifting pads 100 and 105 should be under the rack at this point.

If using the clamp 255, then step 330 is performed next; if using the clamp 55, step 330 is skipped. At step 330, each lifting pad 205 and 210 is moved along it's respective arm to shorten the distance between fixed lifting pad 200 and the moveable lifting pads 205 and 210 such that movable lifting pads 205 and 210 are placed under the rack 5.

At step 335, the clamp 55/255 is lifted such that the rack 5 is lifted off the floor or pallet. At step 340, the truck 135 is driven, carrying the rack 5, to its drop-off position. At step 345, the clamp is lowered such that the clamp is on the floor (or pallet, if appropriate at this point). If using the clamp 255, then step 350 is performed next; if using the clamp 55, step 350 is skipped. At step 350, each moveable lifting pad 205 and 210 is extended along its respective arm such that movable lifting pads 205 and 210 are clear from all parts on the bottom of the rack 5. At step 355, the arms are opened to an extent such that all parts of the clamp 55/255 are laterally outside of all parts of the rack 5. Then, at step 360, the truck 135 is moved away from the rack 5, such as by backing the truck away from the rack 5. Finally, at optional step 365, the rack 5 is manually rolled into is final position, if necessary.

The steps of the method 300 need not be performed in the order described. Steps may be performed simultaneously or temporally overlapping partially. For example, step 310 may be performed before step 305, or steps 305 and 310 may be performed simultaneously or temporally overlapping partially.

### CONCLUSION

The terms and descriptions used above are set forth by way of illustration and example only and are not meant as limitations. Those skilled in the art will recognize that many variations, enhancements, and modifications of the concepts described herein are possible without departing from the underlying principles of the invention. For example, skilled persons will appreciate that the subject matter of any sentence or paragraph can be combined with subject matter of some or all of the other sentences or paragraphs, except where such combinations are mutually exclusive. The scope of the invention should therefore be determined only by the following claims, claims presented in continuation or reissue patent applications, and equivalents to the foregoing claims.

1. A clamp configured to be connected to a materials-handling vehicle and configured to lift and carry in a data center a rack housing electronic equipment, the clamp comprising:
a frame configured to be connected to a vertically moveable mast of the materials-handling vehicle; and
a pair of opposing arms connected to the frame, each arm being horizontally moveable relative to the frame such that the arms can move inward toward each other and outward away from each other, wherein the frame and the pair of opposing arms form a generally C-shaped variably sized interior space depending on positions of the arms;
each arm comprising:
a lifting pad on or near a bottom of the arm and configured to fit underneath the rack on a side of the rack; and
an inward-facing surface configured to snugly contact or be nearby a side of the rack when the arms are in a closed position.

2. A clamp according to claim 1, wherein each arm further comprises a load stop along an edge of the arm distal from the frame, the load stops configured to inhibit tipping of the rack away from the frame.

3. A clamp according to claim 1, further comprising:
one or more actuators connected to the frame and to each of the arms and configured to cause the arms to move towards and away from each other.

4. A clamp according to claim 1, wherein the inward-facing surfaces are padded.

5. A clamp according to claim 1, wherein each arm further comprises a back stop proximate to the frame.

6. A clamp according to claim 1, wherein each arm is L-shaped, wherein the lifting pad is a bottom base of the L.

7. A clamp according to claim 1, wherein the clamp is moveable between an open position and a closed position, wherein the open position is characterized by an opening at a distal end greater than a width of the rack, and wherein the closed position is characterized by the inward-facing surfaces approximately matching the width of the rack.

8. A clamp according to claim 1, further comprising:
one or more rack-aligning tabs extending distally from the distal side of each arm, the rack-aligning tabs configured to urge a rack into alignment with the clamp by contacting a side or corner of the rack.

9. A clamp according to claim 8, wherein the rack-aligning tabs comprise padding on an inward-facing surface of rack-aligning tabs.

10. A clamp according to claim 1, wherein the electronic equipment is computer server equipment.

11. A clamp according to claim 1, wherein the lifting pad on each arm protrudes toward the opposite arm.

12. A clamp according to claim 1, wherein the lifting pad on each arm protrudes toward the frame, the frame further comprising a fixed lifting pad near a bottom of the frame and configured to fit underneath the rack on a side of the rack, and wherein each arm has an adjustable mechanism, such that the lifting pad on each arm is movable along at least a portion of the length of each lifting pad's respective arm.

13. A clamp according to claim 12, wherein the adjustable mechanism on each arm comprises an electric actuator configured to move a lifting pad proximate a distal end of its arm further and closer to the fixed lifting pad of the frame.

14. A materials-handling vehicle comprising:
a vertically moveable mast;
a carriage connected to the vertically moveable mast; and
a clamp connected to the carriage, the clamp configured to lift and carry a rack housing electronic equipment, the clamp comprising:
a frame connected to a vertically moveable mast of the materials-handling vehicle; and
a pair of opposing parallel arms connected to the frame, each arm being horizontally moveable relative to the frame such that the arms can move inward toward each other and outward away from each other;
each arm comprising:
a lifting pad on a bottom of the arm and configured to fit underneath the rack on a side of the rack; and
an inward-facing surface configured to snugly contact or be nearby a side of the rack when the arms are in a closed position.

15. A materials-handling vehicle according to claim 14, wherein each arm further comprises a load stop along an edge of the arm distal from the frame, the load stops configures to inhibit tipping of the rack away from the frame.

16. A materials-handling vehicle according to claim 14, wherein the carriage is configured to tilt, swivel, or twist.

17. A materials-handling vehicle according to claim 14, wherein the vehicle is one from a group consisting of a counterbalanced sit-down lift truck and a mast tugger.

18. A materials-handling vehicle according to claim 14, further comprising:
a sensor positioned and configured to detect a presence of the rack.

19. A materials-handling vehicle according to claim 18, wherein the sensor is positioned on the mast, below the mast, on the carriage, or on the clamp.

20. A materials-handling vehicle according to claim 14, wherein the clamp is removeable from the carriage.

21. A materials-handling vehicle according to claim 14, wherein the clamp is configured to carry the rack oriented with longer sides of the rack parallel to the frame and shorter sides of the rack parallel to the arms.

22. A materials-handling vehicle according to claim 14, wherein the clamp is configured to carry the rack oriented with shorter sides of the rack parallel to the frame and longer sides of the rack parallel to the arms.

23. A method for moving a rack of electronic equipment in a data center using a materials-handling vehicle comprising a mast and a clamp connected to the mast on one side of the materials-handling vehicle, wherein the clamp comprises two opposing arms, the method comprising:
driving the materials-handling vehicle to a position such that the clamp faces the rack;
opening the clamp into an open position characterized by the opposing arms of the clamp separated by a distance that exceeds a width of the rack;
driving the materials-handling vehicle such that the rack is within the opposing arms of the clamp;
closing the clamp into a closed position such that the opposing arms of the clamp snugly contact or nearly contact opposite sides of the rack and positioning two lifting pads underneath the rack;
lifting the clamp and thereby the rack therein;
driving the materials-handling vehicle proximate to a desired position of the rack in the data center;
lowering the clamp and thereby the rack therein until the rack is on a floor;
opening the clamp into the open position and removing the two lifting pads from underneath the rack; and
driving the materials-handling vehicle, sans the rack, to a displace the clamp from the rack.

24. A method according to claim 23, wherein the rack comprises new or refurbished electronic equipment, an initial position of the rack is a lorry or loading area, and the desired position is an operational position within an interior of the data center.

25. A method according to claim 23, wherein the rack is on a pallet in its initial position.

26. A method according to claim 23, wherein the rack comprises used or broken electronic equipment, an initial position of the rack is an operational position within an interior of the data center, and the desired position is a lorry or loading area.

27. A method according to claim 23, wherein each arm bears one of the two lifting pads and each lifting pad has a variable position along its respective arm, the method further comprising:
extending the positions of the lifting pads away from the materials handling vehicle such that the lifting pads extend beyond the distal side of the rack before closing the clamp into the closed position; and
retracting the positions of the lifting pads towards the materials handling vehicle after closing the clamp into the closed position and before lifting the clamp and thereby the rack.
